(19) United States
(12) Patent Application Publication
(10) Pub. No.: US 2002/0087798 A1
(43) Pub. Date: Jul. 4, 2002

(54) System and method for adaptive data caching

(76) Inventors: Vijayakumar Perincherry, Gaithersburg, MD (US); Erik Richard Smith, Encinitas, CA (US); Paul Alan Conley, Centreville, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/778,716

(22) Filed: Feb. 8, 2001

Related U.S. Application Data
(63) Continuation-in-part of application No. 09/711,881, filed on Nov. 15, 2000.

(51) Int. Cl. G06F 13/00

(52) U.S. Cl. 711/133; 711/167

(57) ABSTRACT

A system and method for selecting database objects to be stored in a cache based on the cache-worthiness of the objects. The technique collects cache-worthiness data for a plurality of objects in a database, determines a cache-worthiness value using the collected data for each of the plurality of objects, and selects one or more of the plurality of objects to be stored in the cache, wherein the objects are selected using the values.

### CROSS-REFERENCE TO RELATED APPLICATIONS

This application is a continuation-in-part of co-pending U.S. Pat. application Ser. No. 09/711,881, entitled “System and Method for Routing Database Requests to a Database and a Cache,” filed on Nov. 15, 2000, the entirety of which is incorporated herein by reference.

### BACKGROUND

1. Field of the Invention

The present invention relates generally to computer databases and more particularly to a system and method for selecting database objects for caching.

2. Discussion of the Related Art

Many computer applications today utilize a database to store, retrieve, and manipulate information. Simply put, a database refers to a collection of information organized in such a way that a computer program can quickly select desired pieces of data. For example, an individual might use a database to store contact information from their rolodex, such as names, addresses, and phone numbers, whereas a business entity might store information tracking inventory or customer orders.

Databases include the hardware that physically stores the data, and the software that utilizes the hardware's file system to store the data and provide a standardized method for retrieving or changing the data. A database management system (DBMS) provides access to information in a database. This is a collection of programs that enables a user to enter, organize, and select data in a database. The DBMS accepts requests for data (referred to herein as database requests) from an application program and instructs the operating system to transfer the appropriate data. Database requests can include, for example, read-only requests for database information (referred to herein as informational database requests) and requests to modify database information (referred to herein as transactional database requests). With respect to hardware, database machines are often specially designed computers that store the actual databases and run the DBMS and related software.

FIG. 1A depicts a conventional database configuration 100A, wherein a computer application 102 accesses information stored in a database 104 having a DBMS 120. Application 102 includes application 110 a database driver 114. Application 102 and database 104 interact in a client/server relationship, where application 102 is the client and database 104 is the server. Application 110 establishes a connection 130 to DBMS 120 using database driver 114. Database driver 114 provides an Application Programming Interface (API) that allows application 110 to communicate with database 104 using function calls included in the API. Conventional database drivers 114 typically handle communication between a client (e.g., application logic 110) and a single database server, or possibly between multiple servers of the same basic type. Many conventional database drivers 114 make use of a proprietary client/server communication protocol (the proprietary connection is shown as line 130 in FIG. 1A).

The performance of the conventional client/server database design depicted in FIG. 1A can be improved with the addition of a cache. FIG. 1B depicts a database subsystem 150 that includes database 104 and a database cache 106. Traditional databases 104 are characterized by high data storage capacity. A database cache, on the other hand, functions as a complement to the database, having lower storage capacity but faster operation. Cache 106 provides rapid access to a relatively small subset of the database information stored in database 104. The faster response time of cache 106 can provide an increase in performance for those database requests that are handled by the cache. The design of database subsystem 150 seeks to maximize usage of the limited storage space available within cache 106 to improve overall system performance.

What is needed is an improved system and method for selecting database objects to be stored in a database cache, such that system performance is improved.

### SUMMARY OF THE INVENTION

The present invention provides a system and method for selecting database objects to be stored in a cache based on the cache-worthiness of the objects, including collecting cache-worthiness data for a plurality of objects in a database, determining a cache-worthiness value using the collected data for each of the plurality of objects, and selecting one or more of the plurality of objects to be stored in the cache, wherein the objects are selected using the values.

According to the present invention, objects are selected for caching based on their cache-worthiness. An object's cache-worthiness value represents a measure of confidence in the belief that the object should be cached. Cache-worthiness data is collected that can support or reject this belief, such as utilization of processing resources and object requests. This data is used to update cache-worthiness values over time, adapting to the changing cache-worthiness of objects. The cache population at any given time should therefore reflect those objects currently deemed to be cache-worthy.

According to an example embodiment of the present invention, a computationally efficient approach based on an adaptive selection model is employed to determine cache-worthiness based on collected cache-worthiness data. Various types of cache-worthiness data can be used to determine the cache-worthiness of database objects.

According to another example embodiment of the present invention, the cache-worthiness determination takes into account the diminishing marginal utility of information. Cumulative cache-worthiness data is afforded progressively less weight when determining an object's cache-worthiness. Methods for selecting objects for caching according to the present invention are therefore able to adapt quickly upon sudden changes in the application environment, or at the birth of a new usage pattern.

The cache population is automatically managed according to the present invention. Objects are identified based on their cache-worthiness. As more cache-worthiness data is collected, the cache-worthiness determinations become more accurate resulting in ever more efficient caching strategies. Further, automating this process relieves the system administrators and database administrators from the responsibility of optimizing database design and tuning. However, the database usage patterns tracked according to example embodiments described herein can be used as desired by database engineers to tune the database to improve performance.

In an embodiment of the present invention, database information is manipulated at an object level rather than at the table level. Selection of the cache population can therefore be applied to finer levels of database objects than tables, such as columns or views. As a result, cache resources can be utilized with maximum efficiency.

These and other features and advantages of the present invention will become apparent from the following drawings and description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A depicts a conventional database configuration, wherein a computer application accesses information stored in a database having a DBMS.

FIG. 1B depicts a database subsystem that includes a database and a database cache.

FIG. 2 is a flowchart that describes a method according to an example embodiment of the present invention for selecting objects from a database for caching.

FIG. 3 is a graphical representation of a cache-worthiness function according to an example embodiment of the present invention, with cache-worthiness represented on the vertical axis and accumulated cache-worthiness data represented on the horizontal axis.

FIG. 4 depicts a conventional inline database configuration, wherein a cache is inserted between an application and a database.

FIG. 5A depicts a parallel cache configuration, wherein a cache is connected in parallel with a database.

FIG. 5B depicts a parallel cache configuration in greater detail according to an example embodiment of the present invention applying the methods described herein for selecting objects for caching.

FIG. 6 depicts the operations of a cache agent in greater detail according to an example embodiment of the present invention implementing the method described herein for selecting objects based on requests.

FIG. 7 depicts the operations of a controller, also according to an example embodiment of the present invention implementing the method described herein for selecting objects based on requests.

FIG. 8 summarizes the communications between a cache agent, a controller, and a replication component according to an example embodiment of the present invention.

FIG. 9A depicts a first example hardware configuration, wherein the cache is implemented using computer hardware separate from the application server.

FIG. 9B depicts a second example hardware configuration, wherein the cache and application server share common computer hardware.

FIG. 9C depicts a third example hardware configuration, wherein the database utilizes multiple servers.

FIG. 9D depicts a fourth example hardware configuration, wherein multiple applications operate on one or more client computers.

FIG. 9E depicts a fifth example hardware configuration employing two or more caches.

FIG. 9F depicts a sixth example hardware configuration employing two or more databases.

FIG. 10 depicts an online database system according to an example embodiment of the present invention.

### DETAILED DESCRIPTION

The present invention provides a system and method for selecting database objects for storage in a database cache. Generally speaking, according to the present invention database objects are selected for caching based on their cache-worthiness. Object cache-worthiness is adjusted over time as cache-worthiness data is collected; the population of the cache is reevaluated every so often to reflect current cache-worthiness values. Various types of cache-worthiness data and formulations for updating cache-worthiness values are described herein.

An overview of a method according to the present invention for selecting objects for caching based on cache-worthiness is first presented. This is followed by a discussion of the mathematical model underlying the methods described herein, including an example approach for determining cache-worthiness in a computationally efficient manner. Methods according to various embodiments of the present invention are then described that employ this computationally efficient approach. Finally, various applications of these methods to different hardware configurations are described, including an example web-accessible database application.

### Overview

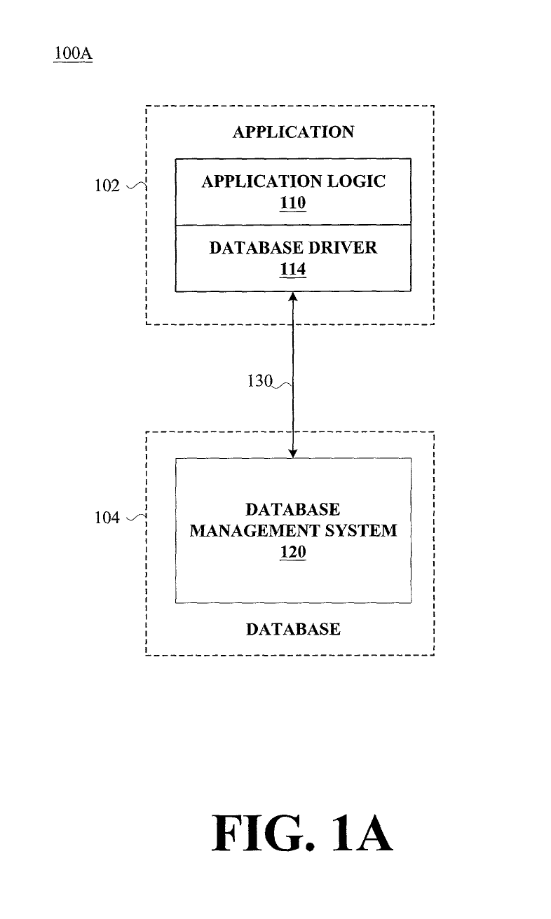

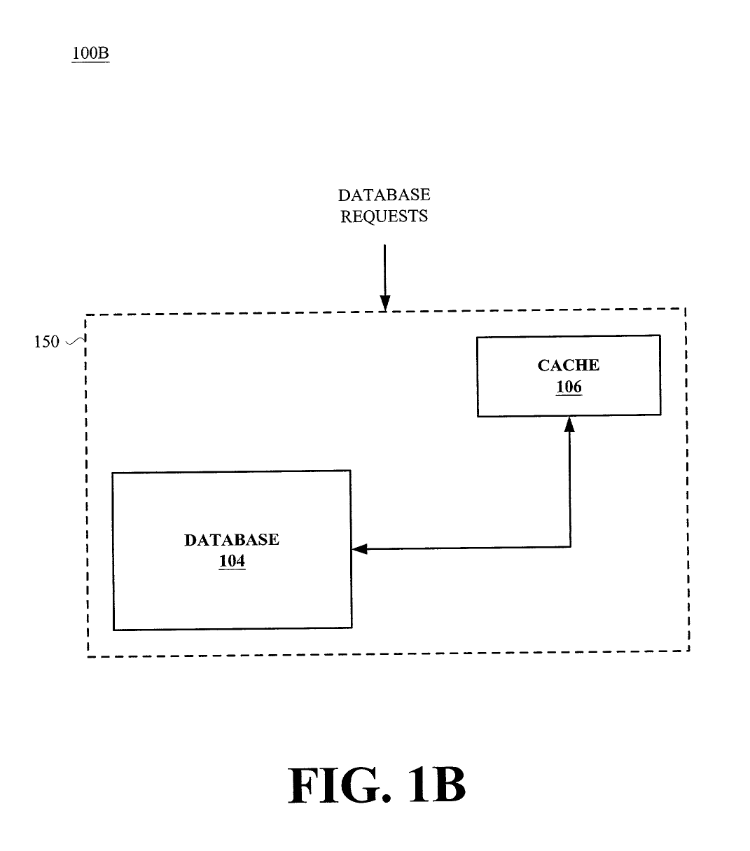

Returning to FIG. 1B, in database subsystem 150 one or more of the objects stored in database 104 are selected according to the present invention to be stored in cache 106. Database 104 represents computer software that utilizes the database hardware's file system to store database information and provide a standardized method for retrieving or changing the data. According to an example embodiment of the present invention, database 104 (and cache 106) store database information as relational data, based on the well known principles of Relational Database Theory wherein data is stored in the form of related tables. Many database products in use today work with relational data, such as products from INGRES, Oracle, Sybase, and Microsoft. Other alternative embodiments can employ different data models, such as object or object relational data models.

As described above, cache 106 provides rapid access to a subset of the database information stored in database 104. Cache 106 processes database requests from a connection established by a client and returns database information corresponding to the database request (target data). The object within which the target data is found is referred to herein as the target object. The faster response time of cache 106 provides an increase in performance for those database requests that can be handled by the cache.

The database information stored in database 104 and cache 106 can be broken down into various components, wherein the components can be inter-connected or independent. Depending upon their functionality and hierarchy, these components are referred to within the relevant art as, for example, tables, columns (or fields), records, cells, and constraints. These components are collectively referred to herein as objects (or database objects).

According to the present invention, caching of information stored in database 104 is performed at a database object level. The present invention therefore encompasses caching of database 104 at any desired level of granularity, depending upon the definition of a database object for a particular application. For example, caching of a restricted number of constituent columns and records from a restricted number of tables is contemplated, rather than having to resort to caching tables in their entirety. It will be apparent that the appropriate granularity of the caching scheme will depend upon the types of database requests supported. For example, record level caching may be appropriate for point queries, whereas view level caching may be appropriate where frequent table joins are involved. Column level caching is generally applicable as long as all relational and indexing constraints are adhered to.

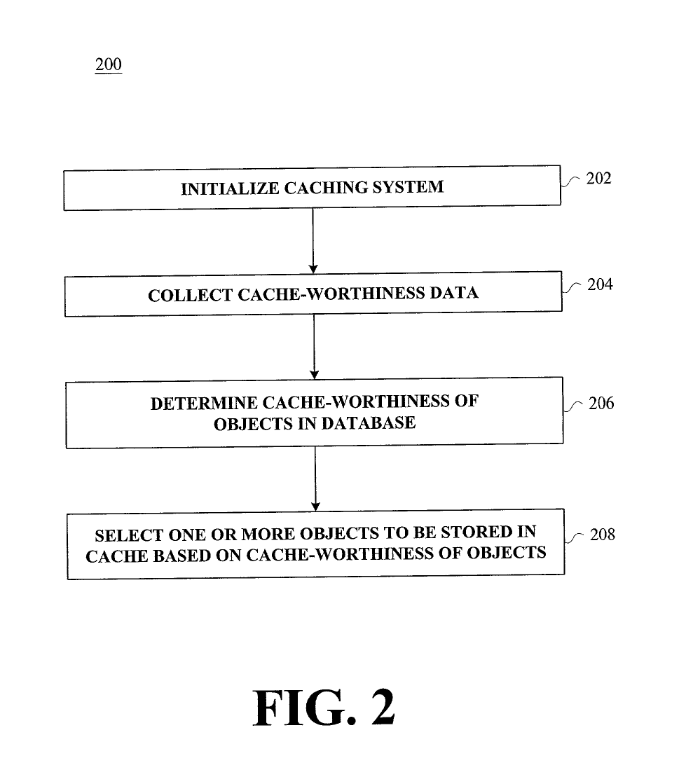

FIG. 2 is a flowchart that describes a method according to the present invention for selecting objects from database 104 for caching in cache 106. In operation 202, cache 106 is initialized prior to operation, such as at system start-up. In operation 204, cache-worthiness data is collected. In operation 206, cache-worthiness values for at least a subset of the objects in database 104 are determined based on the collected cache-worthiness data. In operation 208, one or more objects are selected for caching in cache 106 based on object cache-worthiness, wherein the objects are selected from the subset of objects for which cache-worthiness values were calculated.

The present invention includes one or more computer programs which embody the functions described herein and illustrated in the appended flowcharts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flowcharts and associated written description included herein. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

The following section describes an adaptive selection model according to the present invention that is based on the general concept of cache-worthiness.

### Adaptive Selection Model

According to the present invention, objects stored in a database are selected for caching based on an adaptive selection model. The model represents an analytical approach to identifying those objects which, if cached, would most benefit system performance. Using this model, the population of the cache is adaptively managed to maximize performance improvements obtained using the cache. The model is adaptive in the sense that it continually reviews database usage patterns and revises the solution.

Central to the model described herein is the cache-worthiness of database objects. Simply put, the cache-worthiness of an object refers to a measure of confidence in the belief that the object should be cached. A high cache-worthiness value indicates a strong belief that an object should be cached. A low cache-worthiness value indicates a strong believe that the object should not be cached. A neutral cache-worthiness value indicates that there is insufficient evidence upon which to base a belief. An object's cache-worthiness can also vary over time due to various factors, such as a time-varying demand for the object that causes the object to be accessed many times during certain periods, and infrequently during others.

According to the present invention, cache-worthiness can be measured using techniques founded on the principles of multi-valued logic. For example, cache-worthiness can be calculated as an aggregation of properly weighted evidence (referred to herein as cache-worthiness data) supporting or rejecting the belief that the object should be cached. Cache-worthiness data can take different forms because various types of evidence can support or reject whether an object should be cached. For example, evidence related to the marginal impact that caching an object has on system performance is very useful information when determining the cache-worthiness of the object. Here, evidence indicating that caching an object increases system performance tends to support the belief that the object should be cached. Conversely, evidence indicating the opposite tends to reject the belief that the object should be cached.

According to this formulation, the cache-worthiness of an object can be defined analytically in terms of the marginal impact its caching has on server performance. Central processor unit (CPU) utilization of the server(s) hosting database 104, K, can be expressed at a specific cross-section of time t as:

K_{t=Σn}ᵢyᵢ(1−xᵢ)

Where:

nᵢ is the number of requests for object i in the system at time t

yᵢ is the CPU utilization for processing object i

xᵢ is a binary cache-indicator for object i (0 if not cached, and 1 if cached).

The cache-worthiness of object i can be expressed as the derivative of K with respect to xᵢ:

$$\frac{\partial K}{\partial {x}_{i}} = - {n}_{i} {γ}_{i}$$

Given this formulation for cache-worthiness, objects having relatively high values of ∂K/∂xᵢ are the most appropriate for caching. However, nᵢ and yᵢ are not constant values. For example, time of day, database size, and a number of other processes in the system can cause these values to vary over time. Though basing a caching strategy on marginal CPU impact can, in some sense, tend towards an optimal solution, an analytical formulation of marginal impacts can be difficult to achieve. Further, such an analytical formulation will be non-convex such that a closed form solution for a global optimum is difficult to find, and must also be recalculated over time as the underlying processes vary.

According to an example embodiment of the present invention, objects are selected for caching based on their cache-worthiness using a heuristic founded on the principles of Uncertainty Theory. The approach validates the truth-values of alternative strategies by monitoring their impacts on the outcome objective. Caching strategies are selected from the entire collection of strategies based on these truth-values. The vector of cached objects is given by Xₜ, where Xₜ is a collection of xᵢ at any point in time t. The derivative of CPU utilization with respect to the changing vector of cached objects is given by:

$$\frac{\partial K}{\partial X} = \frac{( \frac{\partial K}{\partial t} )}{( \frac{\partial X}{\partial t} )}$$

The minima of the foregoing expression is reached when ∂K/∂X=0, or when ∂K/∂t=0. This indicates that effective caching is achieved when server utilization is at equilibrium.

However, this solution does not guarantee a global minimum, since the server utilization function is not convex. The heuristic according to an example embodiment of the present invention therefore forces the solution out of local minima.

The basic principle behind the heuristic is the validation of cause-effect propositions such as:

### If Object i is Cached, then Server Performance K Improves.

Cache-worthiness data is collected, where the data may support or reject this basic proposition. Cache-worthiness data showing that K improves is counted as evidence in favor of the proposition associated with the objects in cache. Conversely, cache-worthiness data showing that K degrades is counted as evidence rejecting the proposition. Putting this in analytical terms, at time t CPU utilization is given by Kₜ. The objects in the cache are represented by the vector Xₜ. The vector Cₜ represents the cache-worthiness associated with each of the objects stored in the database for which cache-worthiness values are tracked, and is given by {c_{i,t} for all i such that c_{i,t}=[−1,+1]}.

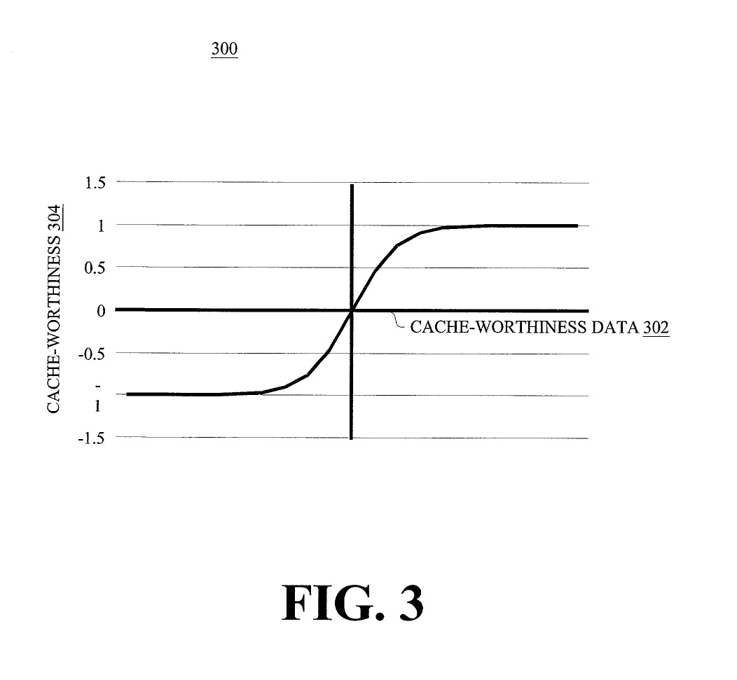

Consider the following functional form for c_{i,t}:

$$\frac{( {e}_{t}^{n} - 1 )}{( {e}_{t}^{n} + 1 )}$$

where n≈[−∞,+∞] is the cumulative level of evidence at time t. FIG. 3 is a graphical representation of this function, with cache-worthiness represented by a vertical axis 304 and accumulated cache-worthiness data represented by a horizontal axis 302. The function for cₙ lies within the range [−1,+1] for all values of n between−∞ to+∞, though it will be apparent that this function can be scaled arbitrarily to achieve any desired range without departing from the ideas described herein. As shown in FIG. 3, as positive cache-worthiness data is collected with respect to an object (i.e., cache-worthiness data supporting the proposition that the object should be cached), the object's cache-worthiness approaches a value of one. Conversely, as negative cache-worthiness data is collected (i.e., cache-worthiness data rejecting the proposition), the object's cache-worthiness approaches a value of negative one.

The function depicted in FIG. 3 illustrates that cumulative cache-worthiness data, whether positive or negative, is considered to be of decreasing marginal utility. For example, cache-worthiness data is considered to be the most valuable (i.e., the most probative) where there is no confidence in the cache-worthiness proposition, which is reflected as a cache-worthiness value of zero. This is shown in FIG. 3: the slope of the curve is greatest around the origin, where the cache-worthiness value is zero indicating that the cache-worthiness data collected so far is equivocal. Any cache-worthiness data gathered at this point, whether supporting or rejecting the cache-worthiness proposition, causes the greatest change in the resulting cache-worthiness. Small increases (or decreases) in the cache-worthiness data result in relatively large increases (or decreases) in cache-worthiness. As cumulative cache-worthiness data is collected, either positive or negative, the magnitude of the resulting change in cache-worthiness decreases. This reflects the supposition that cache-worthiness data is the most valuable where the greatest uncertainty exists, and becomes less valuable as uncertainty decreases. For example, cache-worthiness data is of little value with respect to those objects for which a high certainty exists that the object should (or should not be) cached. Conversely, cache-worthiness data is of significant value with respect to those objects for which there is no certainty that the object should (or should not be) cached.

It is also useful to note that (1-cₙ*) is a good approximation for (∂c/∂n)_{n=n*}. This approximation provides a computationally efficient approach to calculating the incremental change in cache-worthiness based on an incremental change in cache-worthiness data. For example, an incremental change in cache-worthiness data will cause an approximate change in the object's cache-worthiness value equal to (1-cₙ*) possibly weighted by an appropriate factor. Various applications of this approximation will be discussed in further detail below.

### Method for Adaptively Selecting Objects for Caching

Methods according to the present invention for selecting objects for caching based on the adaptive selection model are now described. Returning to FIG. 2, each of the operations will now be described in greater detail. The operations described in this section are independent of the type of cache-worthiness data used to determine cache-worthiness values. Following sections describe two specific example embodiments utilizing two different types of cache-worthiness data, and a third example embodiment utilizing a combination of these (and other) types of cache-worthiness data.

In operation 202, database subsystem 150 is initialized. According to an example embodiment of the present invention, at time t=0 the X₀ vector is initialized such that a random set of objects is selected to be stored in cache 106, where the xᵢ values corresponding to the randomly selected cached objects are set to one, and the remaining xᵢ values are set to zero. The vector C₀={c_{0,0}, c_{1,0}, c_{2,0}, . . . , c_{n,0}} an be initialized with all zero values, indicating uncertainty as to whether the corresponding objects should be cached. Alternatively, any information known at initialization can be considered when assigning initial cache-worthiness values. This initial information can include objective and subjective cache-worthiness data. Additionally, an initial measurement of CPU utilization, K₀, can also be taken.

According to a first example embodiment, database subsystem 150 tracks the cache-worthiness of every object stored in database 104. In this first embodiment, the cache population is drawn from the entire set of objects stored in database 104. However, database subsystem 150 need not necessarily track the cache-worthiness of all objects stored in database 104. According to a second example embodiment, database subsystem 150 tracks cache-worthiness values for a subset of the objects stored in database 104, and does not track the cache-worthiness of the remaining objects. In this second embodiment, the cache population is drawn from this subset of objects stored in database 104. As will be apparent, this subset of objects can be selected according to a variety of criteria, such as, for example, according to user preference, random order, data size, or type of data.

In operation 204, cache-worthiness data is collected, at least with respect to those objects for which cache-worthiness is being tracked by database subsystem 150. Cache-worthiness data can take many forms, including objective and subjective data. Objective data can include, for example, CPU utilization, requests for particular objects, server response time, query processing time, throughput, query processing rate, and cache miss rate. Subjective data can include data provided by a user that is indicative of the user's subjective belief as to the cache-worthiness of a particular object. For example, if a user believes that it is desirable to cache a particular data object, the user may provide this subjective data which can be considered by the system when determining the cache-worthiness of that object.

The timing of cache-worthiness data collection can vary widely, depending upon a variety of factors such as available system memory and processing resources, desired accuracy of the cache-worthiness measurement, and the type cache-worthiness data being collected. For example, CPU utilization data used at a macro level (described below) can be collected periodically, where the interval between samples can be determined by balancing a variety of factors. Collecting CPU measurements more often allows for tracking rapidly changing system loading, but increases the overhead associated with the measurements. As a related example, collecting CPU utilization data for use at a micro level (also described below) is more event driven in that measurements should occur before and after a particular object is cached in order to determine the marginal impact on system performance. Similarly, collecting object request data is event driven in that the data is collected by examining each database request to determine the target objects of the request.

In operation 206, cache-worthiness values are calculated with respect to those objects for which the cache-worthiness is being tracked by database subsystem 150. According to an example embodiment of the present invention, the cache-worthiness value of those objects for which cache-worthiness data was collected is modified according to the following formulation:

c_{i,t}=c_{i,t}±η(1-c_{i,t})

where η is a calibrated coefficient. The incremental value η(1-c_{i,t}) is added to an object's cache-worthiness if positive cache-worthiness data is collected, and subtracted from an object's cache-worthiness value if negative cache-worthiness data is collected. The value of η can vary according to a variety of factors, such as the relative strength of the cache-worthiness data in terms of it's probative value, the rate of change of the cache contents (e.g., value of η inversely proportional to rate of change), the overall frequency of database access (e.g., lower value of η inversely proportional to rate of access). As described above, the value (1-c_{i,t}) is a good approximation of the incremental change in an object's cache-worthiness resulting from an incremental change in cache-worthiness data. The value of η can therefore reflect, among other things, the magnitude of the incremental change in cache-worthiness data, i.e., the magnitude of incremental changes in an object's cache-worthiness should reflect the magnitude of incremental changes in cache-worthiness data. Various implementations of this formulation are described in greater detail in following sections.

It will be apparent to those skilled in the art that many different formulations for updating an object's cache-worthiness can alternatively be used. The formulation presented above is premised upon the decreasing marginal utility of cache-worthiness data. Alternative formulations can be used that utilize cache worthiness data in different ways. For example, in a stable environment where applications exhibit long-term stability in behavior, a linear change in cache worthiness could be formulated as below:

c_{i,t}=c_{i,t}±η

Objects for caching are selected, at least in part, on the basis of the highest resulting cache worthiness data. Another alternative formulation may be applicable where the cache worthiness computation is based, at least in part, on the number of requests. The quantity:

$$( \frac{{c}_{i , t}}{\sum {c}_{i , t}} )$$

can reflect the “probability” that object i will be requested. Objects for caching are selected, at least in part, on the basis of these probability values.

In operation 208, one or more objects are selected to be stored in cache 106 based on object cache-worthiness values. In general, those objects having relatively high cache-worthiness are selected for caching. As mentioned above, objects are selected from the subset of objects stored in database 104 for which cache-worthiness values are tracked. Selected objects that are not currently stored in cache 106 are copied from database 104 to cache 106. Selected objects that are currently stored in cache 106 remain in the cache. Objects that are currently stored in cache 106, but are no longer selected for caching, are removed from cache 106.

The population of cache 106 can be re-evaluated more or less often, depending upon a variety of factors. For example, some applications may benefit from more frequent swapping of objects in cache 106, particularly where the cache-worthiness of objects varies significantly over time. Also, the computational difficulty of the cache-worthiness calculation can impact how often operation 208 is performed. For example, a particularly computationally intensive cache-worthiness calculation may be performed less frequently to conserve processing resources. Furthermore, operation 208 need not be performed periodically. Objects may be selected and swapped upon the occurrence of an event, such as, for example, when CPU utilization falls outside a designated range.

According to an example embodiment of the present invention, objects are selected to maximize the total cache-worthiness of those objects stored in cache 106, subject to the constraint of available cache memory. This formulation may be described as a linear programming (LP) problem:

Maximize Σc_{i,t+τ}Xᵢsuch that Σsᵢxᵢ≦S where xᵢ₌0/1 for all i

where sᵢ is the size of object i and S is the maximum random access memory (RAM) available. It will be apparent to those skilled in the art that various well known approaches are available for solving this LP problem. The objects corresponding to the selected values c_{i,t+r} are then swapped into cache 106.

The following three sections describe example implementations of the general method of selecting objects for caching described herein. The first utilizes CPU utilization data as cache-worthiness data, the second utilizes object request data, and the third describes combinations of the first two implementations.

### Method For Selecting Objects Based on CPU Utilization

According to an example embodiment of the present invention, the utilization of CPU assets by database 104 is collected as cache-worthiness data, which is then used to calculate cache-worthiness values and to select objects for caching. For example, CPU utilization can be measured every so often; changes in CPU utilization over a given interval can be used as evidence to support or reject the cache-worthiness of the current cache population. The manner in which CPU utilization data is collected can vary from system to system. For example, some servers provide a utility that, when called, returns a measurement of CPU utilization. As will be apparent, other approaches for determining CPU utilization are available. For example, CPU utilization can be calculated on the basis of average number of processes in the queue, arrival rate of processes, and/or the processor rate (MHz).

CPU utilization data can be collected and related to objects at a macro or micro level. Utilizing this data at a macro level, any decrease (or increase) in CPU utilization can be interpreted as evidence that the performance improvement (or degradation) is attributable to the selection of the current cache population. According to an example embodiment, at time t=t+h, CPU utilization is measured as Kₜ₊ₕ, where h is a pre-determined monitoring interval. An updated cache-worthiness vector can be calculated for those objects currently stored in cache 106, using:

c_{i,t+h}=c_{i,t}+εμ(1-c_{i,t})

where ε=Kᵢ-Kₜ₊ₕ is reflective of the change in CPU utilization over the time period h, and where μ is a coefficient. In other words, the cache-worthiness value of each object stored in cache 106 is increased by εμ(1-c_{i,t}) in the event that performance improves. Note that the magnitude of the increase is a function of the magnitude of the performance improvement. Similarly, the cache-worthiness value of each cached object is decreased by the same factor in the event that performance degrades. The magnitude of the decrease is also a function of the magnitude of the performance degradation.

The coefficient μ represents the weight assigned to collected evidence. A low value of μ results in slow adaptation, and longer stabilization times. A high value of μ results in rapid adaptation, but may become unstable. The value of μ should therefore be set between these extremes such that relative rapid adaptation is achieved without instability in the adaptation process. For example, an initial value for μ can be chosen equal to 1/N (where N is the number of database queries per hour for the system). This initial value can then be adjusted up or down to achieve a desired rate for changes in the cache population. As will be apparent, many other schemes can be used to set an initial value for μ.

Exploiting CPU utilization data at a micro level, any decrease (or increase) in CPU utilization can be interpreted as evidence that the performance improvement (or degradation) is attributable to the caching of a particular object. This is distinguished from the macro use of the data, where changes in performance are attributed to the entire cache population. For example, CPU utilization data taken before and after the caching of an object can be used to determine a change in performance possibly attributable to the object. The performance change can be used as evidence of the cache-worthiness of the object. Similar evidence may be collected when an object is removed from the cache, causing an increase or decrease in performance. In this case, the cache-worthiness of the removed object may be adjusted, depending upon whether the removal resulted in an increase or decrease in performance.

The formula given above for the macro use of CPU utilization data can be used for the micro case as well, i.e., the cache-worthiness of the particular object can be adjusted by εμ(1-c_{i,t}), where ε represents the change in CPU utilization as a result of the object being cached. The value of μ can be set, for example, as described above with respect to the macro use of CPU utilization data.

According to another example embodiment, CPU utilization data can be used to perform both macro and micro adjustments in a combined fashion. In this embodiment, periodic vector-level adjustment can be made to all cached objects, as described above. In addition, adjustment can be made to the cache-worthiness of individual objects, where CPU utilization data indicates that system performance was affected by the caching (or removal from the cache) of a particular object. Method For Selecting Objects Based on Requests

According to another example embodiment of the present invention, requests for particular objects are monitored as cache-worthiness data. The assumption underlying this embodiment is that objects requested more often are likely candidates for caching. Similarly, objects that are requested less often are considered less likely candidates for caching. The cache-worthiness value for an object is adjusted each time the object is requested from database subsystem 150 according to:

c_{i,t}=c_{i,t}+η(1-c_{i,t)}

where η is a coefficient set as described above.

The cache-worthiness of a particular object is decreased by a like amount if the object is not requested for a pre-determined period of time. Further, the rate at which negative adjustments are made to cache-worthiness need not be linear, i.e., the period of time between successive negative adjustments to cache-worthiness need not be equal. For example, negative adjustments to cache-worthiness resulting from an object not being requested can occur at successively shorter or longer periods of time, depending upon the desired effect.

This embodiment provides for a computationally efficient approach to collecting cache-worthiness data and updating cache-worthiness values. The target object(s) associated with each user request is noted, and mapped to a corresponding object in database 104. Cache-worthiness values can then be adjusted up or down as objects are requested (or not). The cache-worthiness measurement is also adaptive in that an object's cache-worthiness value will change over time as requests for the object increase or decrease.

### Method For Selecting Objects Using Multiple Criteria

According to the present invention, various other embodiments are envisioned wherein cache-worthiness values are updated using two or more criteria. For example, cache-worthiness values can be updated using a combination of the two previously described example embodiments, i.e., selection based on CPU utilization and selection based on object requests.

According to an example embodiment, object requests are monitored as cache-worthiness data and used to update the cache-worthiness values of requested (or unrequested) objects on a relatively frequent basis. CPU utilization is also monitored as cache-worthiness data. This data is used to make macro adjustments to the cache-worthiness values of the cache population on a less frequent basis than updates based on requests. According to this example embodiment, object requests are used as the primary mechanism for determining cache-worthiness since this update requires relatively less processing resources. This first-level adjustment is backed-up by the second-level adjustments based on CPU utilization, which ensures over time that changes made to the cache population actually improve system performance.

As will be apparent, various combinations of cache-worthiness data can be exploited within the scope and the spirit of the present invention, as well as various update formulations for adjusting cache-worthiness values based on the collected data.

### Application of Caching Methods to Conventional Database Systems

The methods described herein for adaptively selecting objects for caching can be utilized within a variety of database configurations to improve system performance. As depicted in FIG. 1B, methods according to the present invention are applicable to any database subsystem 150 that includes a database and an associated cache. Objects are selected from database 104 for storage in cache 106, regardless of the specific manner in which cache 106 is configured with database 104. Several example embodiments are described to illustrate the general applicability of adaptive selection according to the present invention.

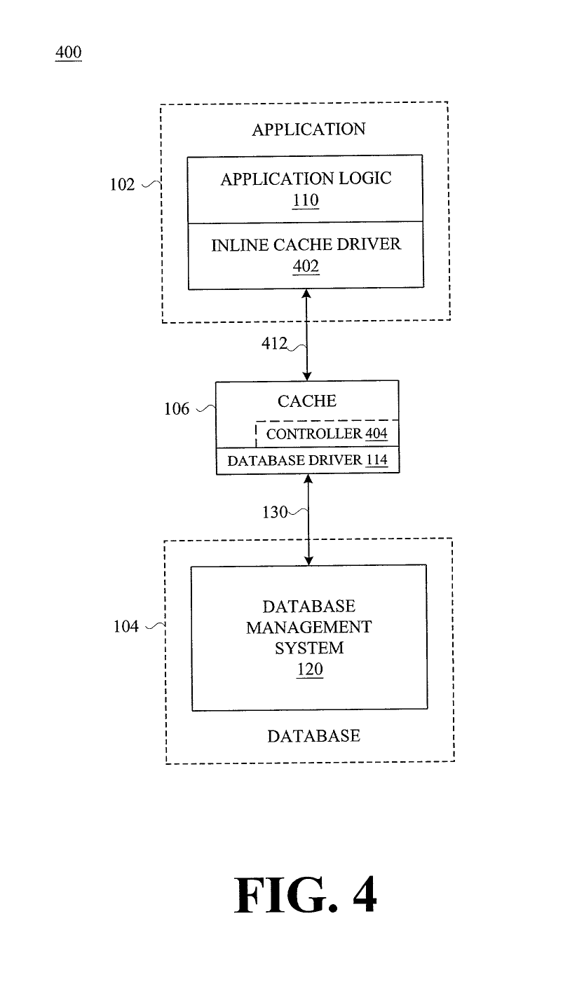

FIG. 4 depicts a conventional database configuration 400 wherein cache 106 is inserted between application 102 and database 104. This configuration is referred to herein as an inline cache. Application 110 uses an inline cache driver 402 to establish a connection with cache 106. Cache 106 provides rapid access to a subset of the database information stored in database 104, as will be apparent to those skilled in the art. Cache 106 establishes connection 130 with DBMS 120 using database driver 114, where the driver can be integrated within the cache. Cache 106 also includes a controller 404 that controls the population of cache 106. As will be apparent, controller 404 need not necessarily be located within cache 106. Alternatively, controller 404 can be located within DBMS 120, or even within inline cache driver 402.

Application 102 can represent any computer application that accesses database 104, such as a contact manager, order tracking software, or any application executing on an application server connected to the Internet. Application 110 represents the portion of application 102 devoted to implementing the application functionality. For example, application 110 can include a graphical user interface (GUI) to control user interactions with application 102, various processing routines for computing items of interest, and other routines for accessing and manipulating database information stored in database 104.

Inline cache driver 402 represents software that can be used to establish a connection to cache 106. Application 110 calls inline cache driver 402 to establish a connection 412, and then passes database requests to cache 106 for processing. Similarly, database driver 114 represents software that can be used to establish a connection to DBMS 120. According to an example embodiment of the present invention, database driver 114 represents the driver software that is distributed by the manufacturer of database 104. As a result, connection 130 can represent a connection established according to the manufacturer's proprietary client/server communication protocol. Inline cache driver 402 and database driver 114 provide APIs that can include a variety of function calls for interacting with cache 106 and DBMS 120, respectively.

The various cache and database drivers described herein support conventional database standards, such as, for example, the Open Database Connectivity (ODBC) and Java Database Connectivity (JDBC) standards. Generally speaking, clients using these types of drivers can generate SQL query requests for the server to process. In another example embodiment, cache 106 also supports the ability to respond to Extensible Markup Language Query Language (XQL) queries which do not specify a particular driver type (driverless) and use an open standard mechanism, such as Hypertext Transfer Protocol (HTTP), for its communication protocol.

All database requests from application 110 are routed first to cache 106. Cache 106 may handle requests differently depending on the type of operation requested and whether the target data is stored in cache 106. For example, informational database requests can be handled by cache 106 without going to database 104, so long as the target data is stored in cache 106. Transactional database requests are performed in both cache 106 and database 104. Consistency between cache 106 and database 104 is maintained because transactional requests are performed on the database information stored in both locations.

The methods described herein can be applied to inline cache 400 to increase the performance of database 104 and cache 106. As shown in FIG. 4, controller 404 can be added to cache 106 to control the cache population according to the present invention. For example, controller 404 can collect cache-worthiness data by monitoring database requests from application 402 to determine which objects from database 104 are being requested. Controller 404 maintains cache-worthiness values for at least a subset of the objects stored in database 104, updating the values every so often as new cache-worthiness data is collected. Controller 404 then swaps objects between database 104 and cache 106 based on object cache-worthiness. Alternatively, controller 404 can collect CPU utilization data from database 104, and base selection of objects for caching on this cache-worthiness data rather than on requests.

As will be apparent, the methods described herein can applied to other conventional database cache configurations. Any database subsystem having a database and a cache can utilize these methods to achieve improvements in performance.

### Application of Caching Methods to Parallel Cache Configuration

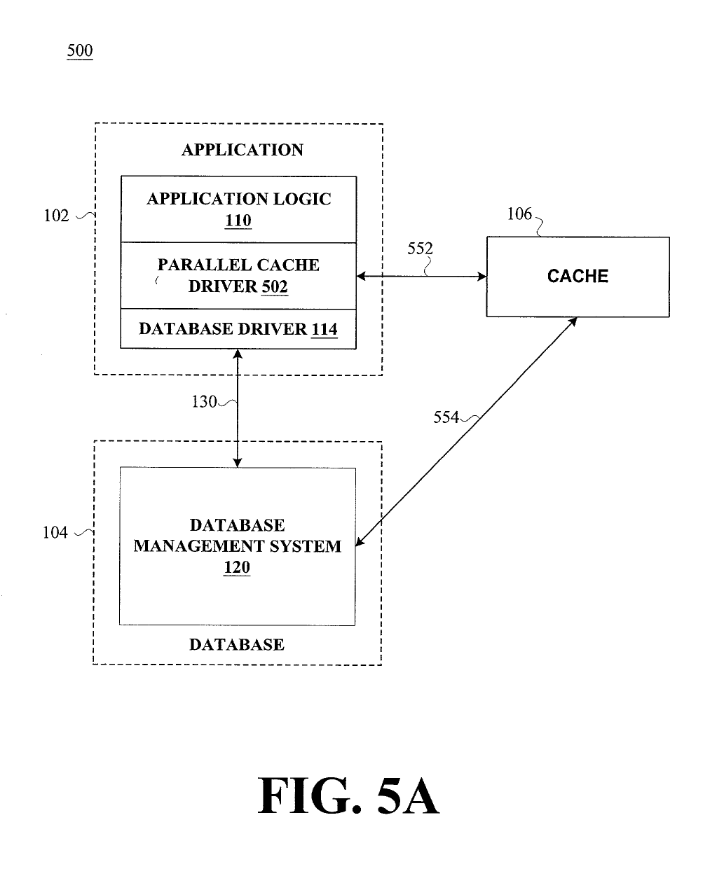

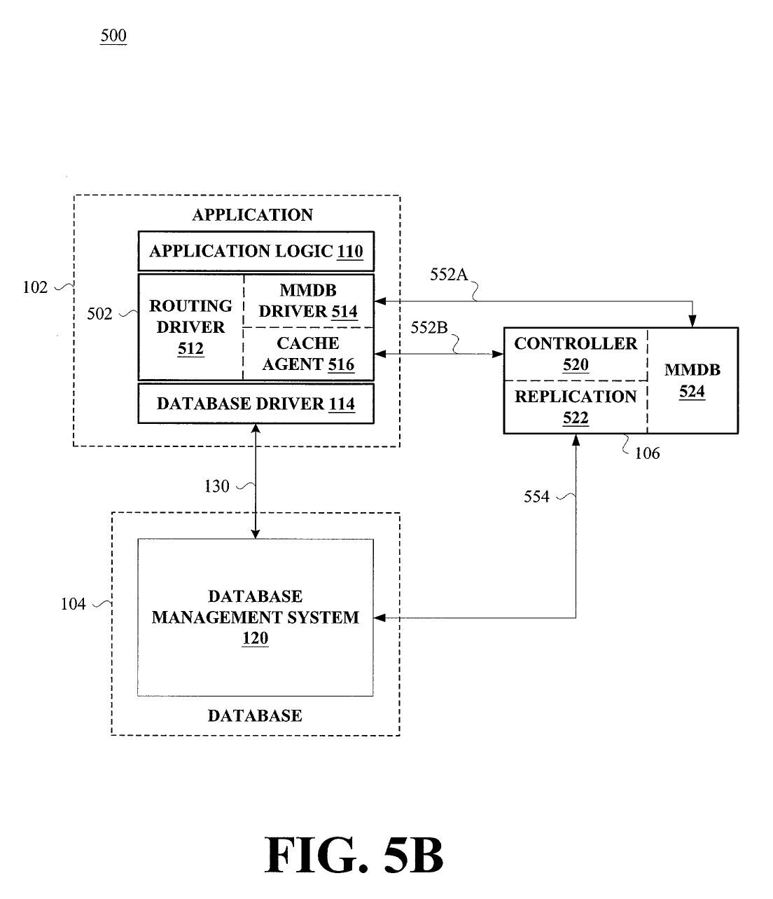

The methods described herein may also be applied to the parallel cache configuration described in co-pending application Ser. No. 09/711,881, incorporated by reference above. FIG. 5A depicts a parallel cache configuration 500, wherein cache 106 is connected in parallel with database 104. Application 102 includes application logic 110, a parallel cache driver 502, and database driver 114. Application 110 establishes a connection 552 with cache 106 by calling cache driver 502. Cache driver 502 calls database driver 114 to establish a connection 130 with DBMS 120. DBMS 120 communicates with cache 106 via connection 554. Parallel cache configuration 500 is described in greater detail in co-pending application Ser. No. 09/711,881.

FIG. 5B depicts parallel cache configuration 500 in greater detail according to an example embodiment of the present invention applying the methods described herein for selecting objects for caching. Cache 106 includes a main memory database (MMDB) 524, a controller 520, and a replication component 522. Cache driver 502 includes a routing driver 512, an MMDB driver 514, and a cache agent 516. Cache 106 represents a high performance computer application running on a dedicated machine. The cache's primary architecture is preferably based on an MMDB. The MMDB provides the ability to process database requests orders of magnitude faster than traditional disk based systems. As will be apparent, other cache architectures may be used. Further, cache 106 may also include a secondary disk based cache (not shown) to handle database requests that are too large to fit in main memory.

Briefly stated, routing driver 512 is responsible for routing database requests from application 110 to cache 106 and/or database 104. Routing driver 512 utilizes MMDB driver 514 to establish a connection 552A with MMDB 524. Requests for objects are passed to MMDB 524, whereupon the requested data if available is returned to routing driver 512. Cache agent 516, controller 520, and replication component 522, working together, are responsible for populating MMDB 524 with objects from database 104 based on object cache-worthiness. Cache agent 516 collects cache-worthiness data and every so often passes the collected data to controller 520. Controller 520 maintains cache-worthiness values for at least a subset of objects stored in database 104, and updates these values as cache-worthiness data is received from cache agent 516. Replication component 522 is responsible for populating MMDB 524 with the objects selected by controller 520. Replication component 522 is also responsible for ensuring that modifications made to objects stored in database 104 are replicated in corresponding objects stored in MMDB 524. Each of these components is described in greater detail below.

Routing driver 512 utilizes MMDB driver 514 to establish connection 552. MMDB driver 514 provides an API that includes various functions for communicating with MMDB 524. As will be apparent, the exact implementation of MMDB driver 514 can vary considerably, depending upon the particular design and functionality of MMDB 524.

Routing driver 512 causes database requests from application 110 to be routed to DBMS 120 and/or cache 106. Routing driver 512 routes requests determined to be appropriate for cache processing to cache 106; those requests determined to be inappropriate for cache processing are routed to database 104. For example, informational requests may be appropriate for cache processing and can therefore be handled by cache 106. Transactional requests, on the other hand, may not be appropriate for cache processing and are therefore be handled by database 104. According to an example embodiment of the present invention, routing driver 512 calls cache agent 516 to make a determination as to whether a particular database request is appropriate for cache processing. Routing driver 512 causes the database request to be routed according to the determination made by cache agent 516.

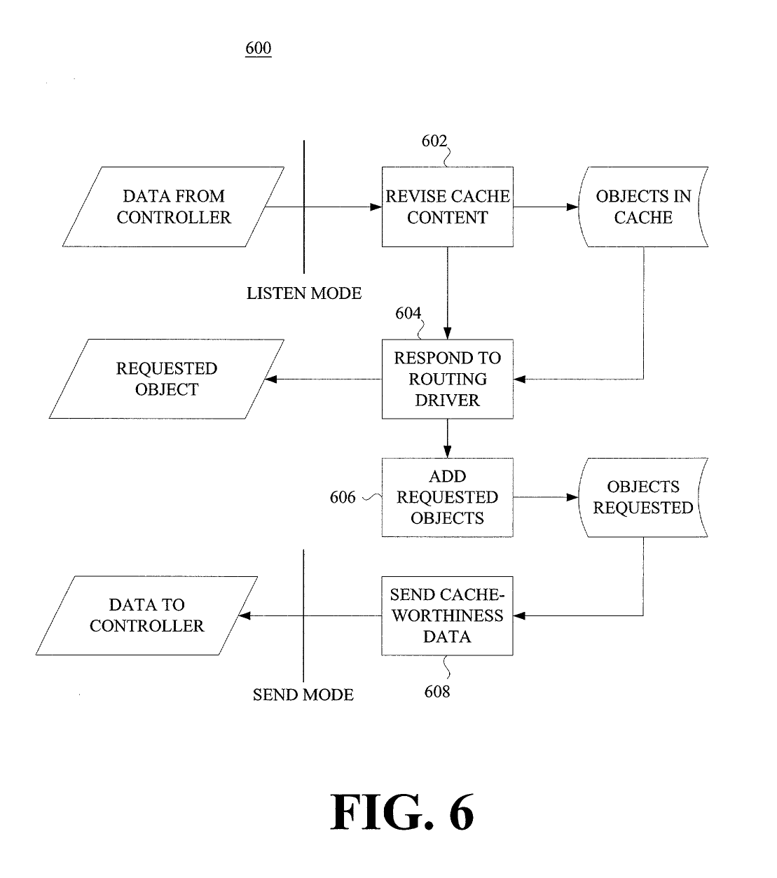

FIG. 6 depicts the operations of cache agent 512 in greater detail according to an example embodiment of the present invention implementing the method described herein for selecting objects based on requests. Cache agent 516 maintains a list of objects currently being stored within MMDB 524. Cache agent 516 uses this list, for example, when assisting routing driver 512 in determining whether a particular database request is appropriate for cache processing. In operation 602, cache agent 516 updates the list of objects based on data received every so often from controller 520.

Upon receiving a database request from application logic 110, routing driver 512 passes the database request on to cache agent 516. Cache agent 516 determines whether the request is appropriate for cache processing, and if so, determines whether the target data is stored within MMDB 524 by referring to the updated list of cached objects. If the request is appropriate for cache processing, and if the object is currently stored in MMDB 524, cache agent 512 directs routing driver 512 to retrieve the object from MMDB 524 (using MMDB driver 514). Otherwise, cache agent 512 directs routing driver 512 to forward the database request to database 104 (using database driver 114) for processing.

Cache agent 516 is also responsible for gathering cache-worthiness data. According to this example embodiment, cache agent 516 monitors the database requests that are received by routing driver 512 from application logic 110. In operation 606, cache agent 516 maintains a list of those objects that are the target of database requests. This information serves as cache-worthiness data according to the methods described above for selecting objects based on requests. As will be apparent, this information can be stored in various locations, such as within cache driver 502, cache 106, or within database 104, depending upon where the data is most easily accessed when making cache-worthiness determinations. Cache agent 516 collects the cache-worthiness data and every so often sends the data to controller 520 as shown in operation 608. Controller 520 maintains the compilation of collected cache-worthiness data. Cache agent 516 therefore need only store the cache-worthiness data collected in the interim between updates to controller 520.

According to an example embodiment, cache agent 516 counts informational database requests as cache-worthiness data, but not transactional database requests. Transactional database requests may not increase object cache-worthiness since these requests are not handled by cache 106 in parallel cache configuration 500. However, other example embodiments may count both informational as well as transactional database requests.

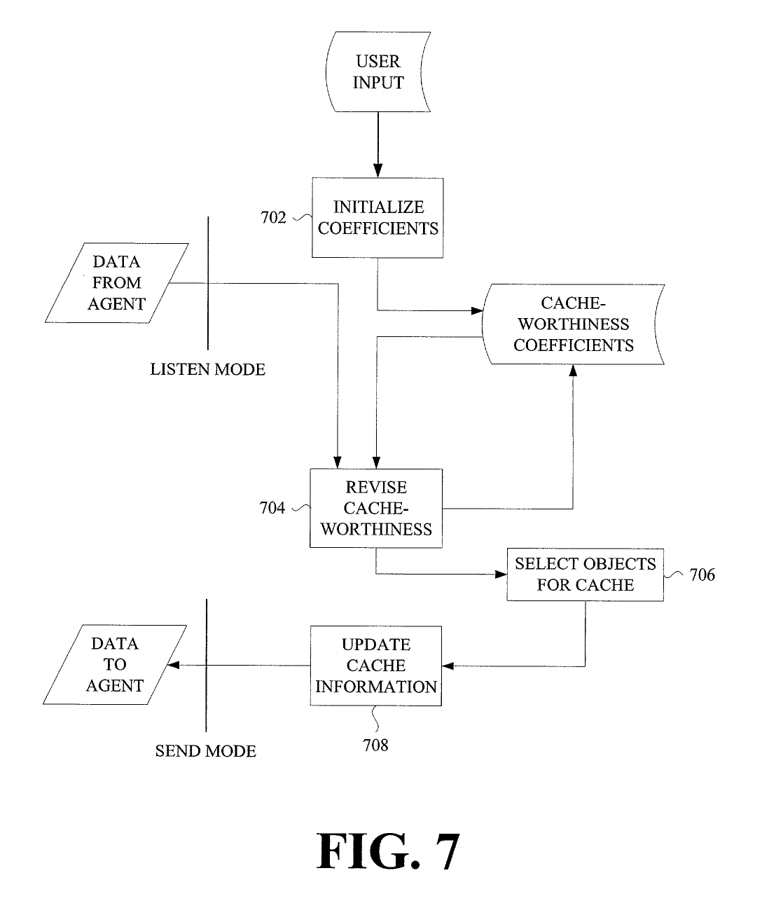

FIG. 7 depicts the operations of controller 520, also according to an example embodiment of the present invention implementing the method described herein for selecting objects based on requests. Controller 520 is primarily responsible for monitoring the cache-worthiness of objects stored within database 104, and for maintaining the population of cache 106 based on object cache-worthiness.

In operation 702, controller 520 initializes a cache-worthiness value for those objects within database 104 with respect to which cache-worthiness values will be tracked.

Cache-worthiness values can be tracked for all objects within database 104, or for some subset of database 104. Where values are tracked for a subset rather than the entire database, the particular subset can be determined either arbitrarily or based on user input. The subset should be chosen to include those objects deemed most likely to be cache-worthy, since it is from this subset that the population of cache 106 will be selected. The user may manually select objects subjectively believed to be the most cache-worthy. Alternatively, controller 520 may select a subset of objects based on historical information, the size of objects, or specific design attributes within the database, such as indexes and keys.

As will be apparent, cache-worthiness values can be scaled to any arbitrary range. In the example discussed above with respect to FIG. 3, cache-worthiness values can vary between−1 and+1, where−1 indicates a strong belief that an object should not be cached, +1 indicates a strong belief that an object should be cached, and zero indicates that the evidence collected so far does not support one belief over the other. Zero can indicate an absence of evidence, or that an equal amount of positive and negative evidence has been collected. These values can be initialized either arbitrarily or based on user input. For example, where no historical cache-worthiness data is available, each object can be assigned an initial cache-worthiness value of zero indicating the lack of currently available evidence. Alternatively, the user may supply an initial cache-worthiness value for one or more objects based on a subjective belief in the object's cache-worthiness.

According to an example embodiment, users can classify objects as one of three categories: (i) objects that are always cached; (ii) objects that can be cached as needed; and (iii) objects that are never cached. With respect to category (i) objects, controller 520 assigns a value of+1 to these objects which insures their caching subject to the limitation of available cache memory. These values may alternatively be fixed, or allowed to vary from the initial value of+1 as cache-worthiness data is collected over time. Similarly, controller 520 assigns a value of−1 to category (iii) objects, insuring that they won't be cached. These values may also be fixed or allowed to vary. Category (ii) objects are given an initial value (e.g., zero) and vary over time as cache-worthiness data is collected.

In operation 704, controller 520 revises cache-worthiness values based on cache-worthiness data received from cache agent 516 according to the methods described herein. For example, according to the selection algorithm based on requests, cache-worthiness values are incremented for those objects that were requested since the last update from cache agent 516. Cache-worthiness values are reduced for those objects that have not been requested for some pre-defined interval.

In operation 706, controller 520 selects one or more objects for caching from those objects for which cache-worthiness values are being tracked. As described above, controller 520 selects objects based on their cache-worthiness. For example, controller 520 can select objects such that total cache-worthiness is maximized, subject to the constraint of available cache memory. As will be apparent, this selection can be accomplished in various ways. Various objective and subjective cache-worthiness data can be considered by controller 520 when selecting objects for caching. For example, controller 520 can consider subjective data provided by the user indicating a preference for certain objects to be cached. As another example, controller 520 can also consider a wide range of objective data, such as object size, object access time, indexing levels, relational keys, or a combination of one or more of these factors. Controller 520 then calls replication component 522 to copy from database 104 those selected objects that are not already stored in cache 106. Objects stored in cache 106 that are no longer selected for caching are deleted from MMDB 524.

In operation 708, controller 520 updates the list of objects that are currently stored in MMDB 524, and sends this data to cache agent 516.

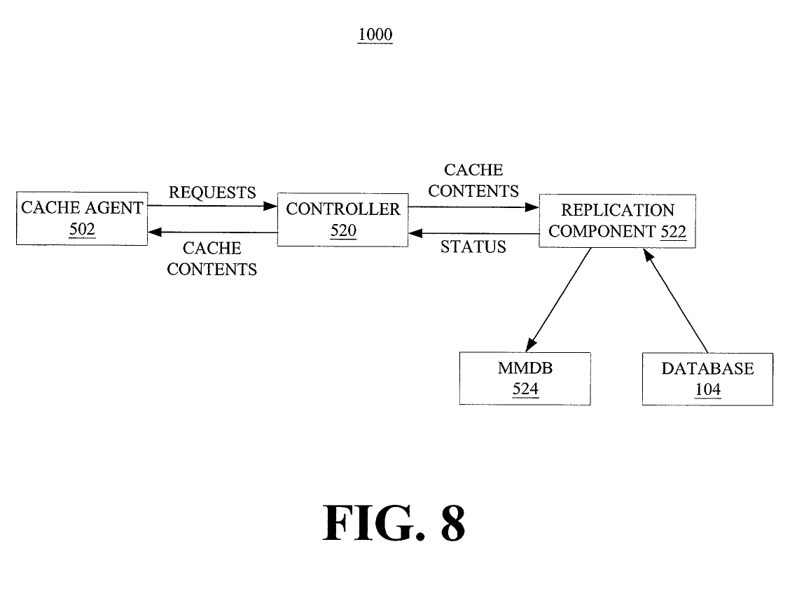

FIG. 8 summarizes the communications between cache agent 516, controller 520, and replication component 522. As described above, cache agent 516 every so often transmits information about requested objects to controller 520, and receives from controller 520 any updates to the contents of MMDB 524. Controller 520 revises the cache-worthiness values of the tracked database objects using the request data from cache agent 516, and updates the cache population accordingly. Controller 520 sends a list of the new cache contents to replication component 522. Replication component 522 copies those objects not already cached from database 104 to MMDB 524. When complete, replication component 522 reports back to controller 520, which in turn sends the updated list of cached objects to cache agent 516.

### Hardware Configurations

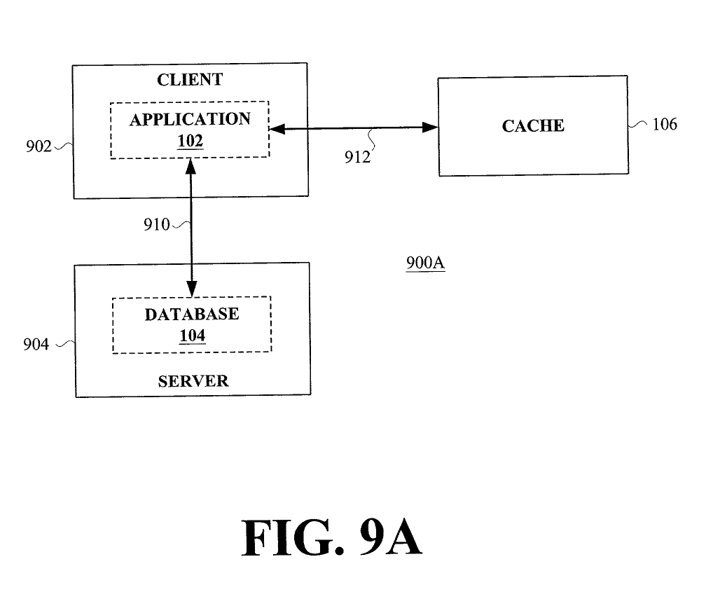

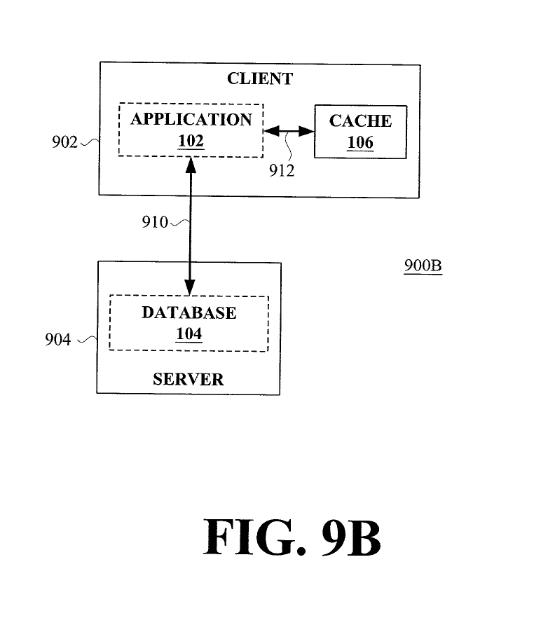

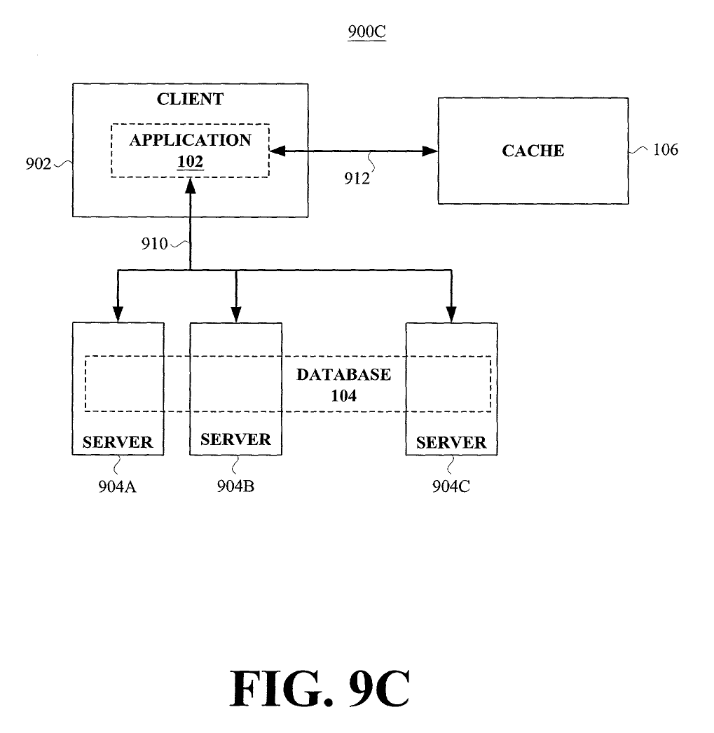

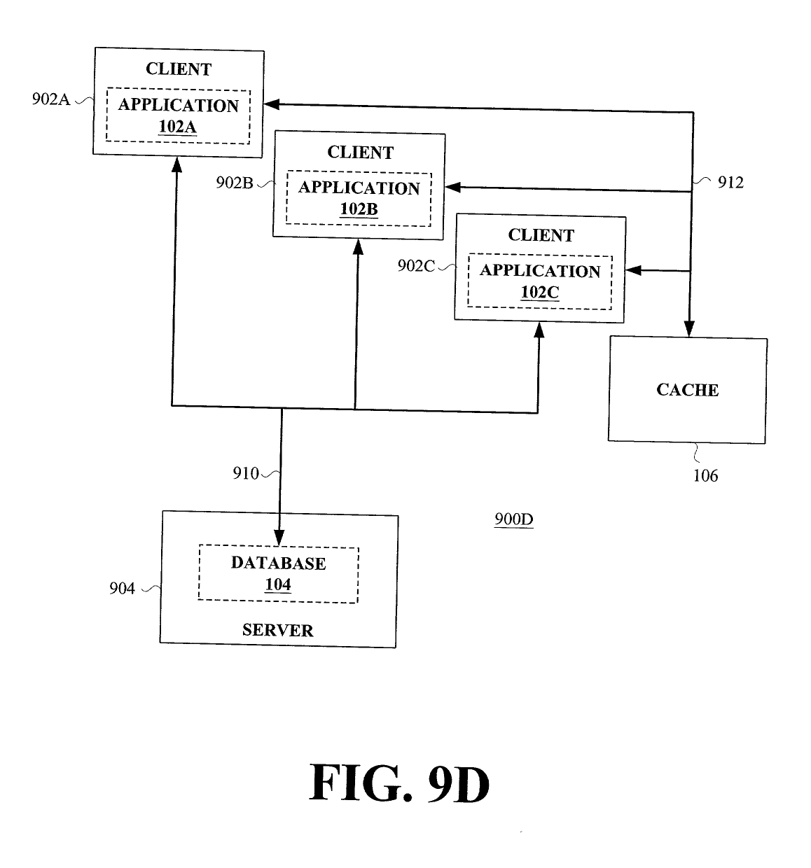

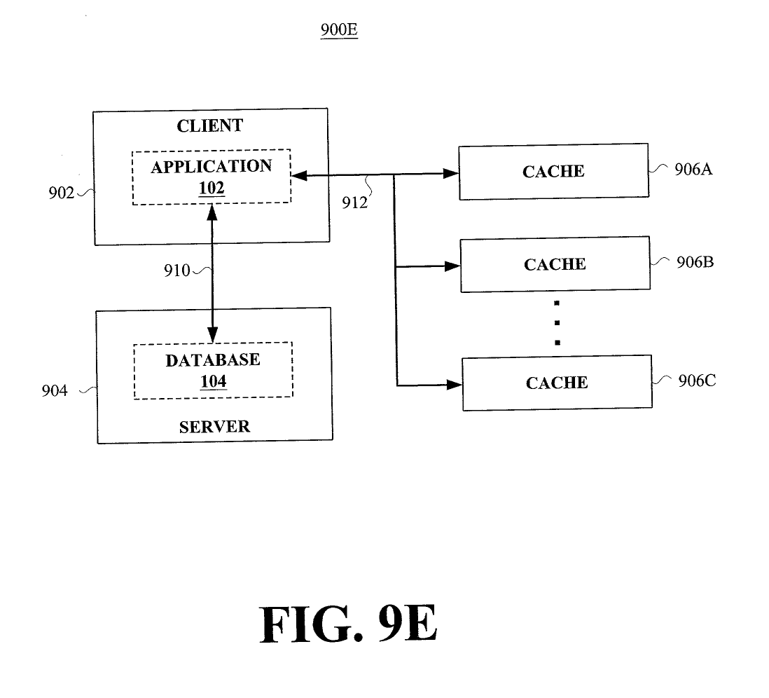

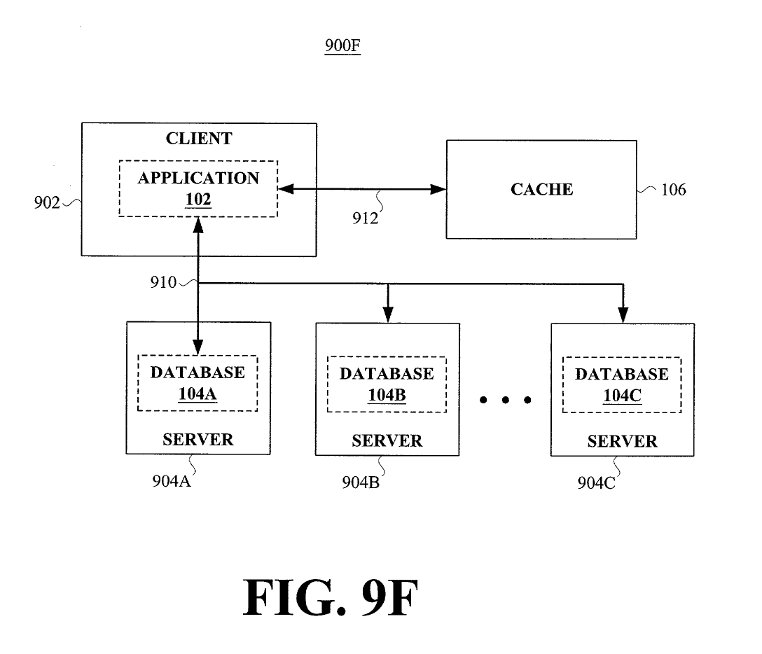

The functional components depicted in FIGS. 5A and 5B can be implemented within various hardware configurations. FIG. 9A depicts a first example hardware configuration 900A, wherein application 102 runs on a client computer 902, in communication with database 104 running on a server computer 904 (via a communication link 910), and in communication with cache 106 (via a communication link 912). In configuration 900A, cache 106 is implemented using hardware separate from client computer 902. By contrast, FIG. 9B depicts a second example hardware configuration 900B wherein cache 106 and client computer 902 share common computer hardware.

FIG. 9C depicts a third example hardware configuration 900C, wherein database 104 utilizes multiple servers 904 (shown as 904A through 904C). The use of multiple servers 904 can be transparent to the client application whose communications with DBMS 120 remain the same regardless of the backend server configuration. FIG. 9D depicts a fourth example hardware configuration 900D, wherein multiple applications 102 (shown as 102A through 102C) operate on one or more client computers 902 (shown as 902A through 902C) to access database 104. As will be apparent from the principles described herein, many other hardware configurations, including various combinations of the example hardware configurations described above, are contemplated within the scope of the present invention.

FIG. 9E depicts a fifth example hardware configuration 900E employing two or more caches 106 (shown as 106A through 106C). According to the present invention, load balancing techniques may be used with multiple cache configuration 900E. Database requests from application 102 may be directed at the cluster of caches in round-robin fashion, thereby distributing the processing burdens across multiple caches. Alternatively, the database information that would have been stored in a single cache may be partitioned and stored across a cluster of caches. This allows for the storage of larger tables than would otherwise be possible using a single cache.

FIG. 9F depicts a sixth example hardware configuration 900F employing two or more databases 104 (shown as 104A through 104C), each operating on a server 904 (shown as 904A through 904C). The population of cache 106 may be drawn from any database 104, according to the techniques described herein. In this manner, a single cache 106 may be used to service multiple databases 104.

Communication links 910 and 912 can represent any connection, logical or physical, over which the information described herein can be transmitted. For example, communication links 910 and 912 can represent a software connection between software modules, cable connection, a local area network (LAN), a wide area network (WAN), the Internet, a satellite communications network, a wireless network, or any combination of the above.

### Example System Operation

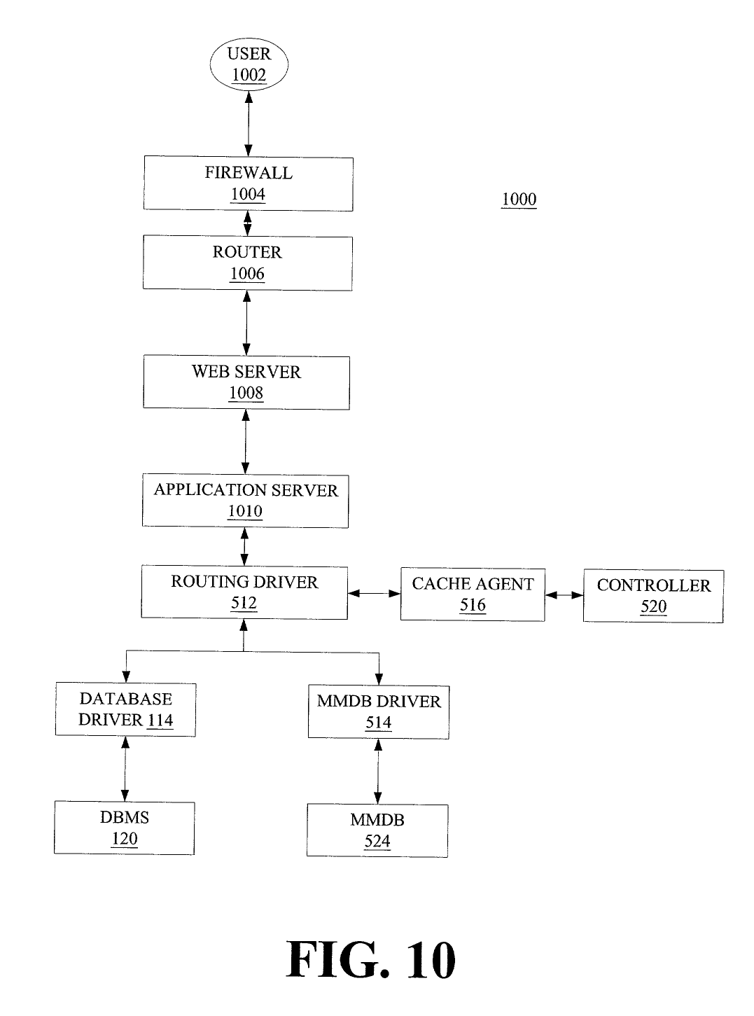

Parallel cache configuration 500 can be employed in many applications. One important application today is servicing database requests received via a network such as the Internet. FIG. 10 depicts an online database system 1000. A user 1002 sends database requests via a firewall 1004 and a router 1006 to a web server 1008 that handles such requests received via the Internet. In this application, a common database request is a request for a dynamic page using HTTP.

An application server 1010 hosts application 102(shown as client server 802 in FIGS. 9A through 9E). Application server 1010 receives the request for a dynamic page, creates the corresponding SQL statement, which is then passed to routing driver 512. As described above, routing driver 512 calls cache agent 516 to determine whether a particular request should be routed to DBMS 120 (via database driver 114) and/or MMDB 524 (via MMDB driver 514). Controller 520 provides cache agent 516 with a list of those objects currently being stored in MMDB 524. Cache agent 516 meanwhile stores the information about the requests as cache-worthiness data.

In this configuration, application 102 can represent an Internet-accessible application that provides, in part, database information to many users 1002. For example, application 102 can represent a web site offering a variety of items for purchase. User 1002 can search the web site for a desired item by entering one or more search terms. The request for searching on these terms is a database request that can be handled either by MMDB 524 and/or DBMS 120. The results of the search are returned to user 1002.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

The previous description of the preferred embodiments is provided to enable any person skilled in the art to make or use the present invention. While the invention has been particularly shown and described with reference to preferred embodiments thereof, it will be understood by those skilled in the art that various changes in form and details may be made therein without departing from the spirit and scope of the invention.

What is claimed is:

1. In a database system wherein objects are stored in a database, a method for selecting one or more of the objects to be stored in a cache, comprising:
(a) collecting cache-worthiness data for a plurality of objects in the database;
(b) determining a cache-worthiness value for each of said plurality of objects using said cache-worthiness data; and
(d) selecting one or more of said plurality of objects to be stored in the cache, wherein the objects are selected using said cache-worthiness values.

2. The method of claim 1, wherein said cache-worthiness data comprises requests for one or more of said plurality of objects.

3. The method of claim 2, wherein said determining comprises adding an increment to those values corresponding to said requests.

4. The method of claim 3, wherein said increment is given by:
η*(1-c_{i,t})
where η is a first constant and c_{i,t} is the cache-worthiness value of object i at time t.

5. The method of claim 4, wherein said cache-worthiness data further comprises an indication that the number of requests for a first object has not satisfied a first threshold, wherein said first object is one of said plurality of objects.

6. The method of claim 5, wherein said determining further comprises subtracting said increment from the cache-worthiness value corresponding to said first object.

7. The method of claim 1, wherein said cache-worthiness data comprises central processing unit (CPU) utilization data.

8. The method of claim 7, wherein said determining comprises adjusting by an increment the cache-worthiness value of each object stored in the cache.

9. The method of claim 8, wherein said increment is given by:
ε(1-c_{i,t})
where ε is indicative of the change in CPU utilization, and c_{i,t} is the cache-worthiness value of object i at time t.

10. The method of claim 7, wherein said CPU utilization data is indicative of a change in CPU utilization from a first time to a second time, said determining comprises adjusting the cache-worthiness value of a first one of said plurality of objects, and said first one of said plurality of objects is added to the cache between said first time and said second time.

11. The method of claim 7, wherein said CPU utilization data is indicative of a change in CPU utilization from a first time to a second time, said determining comprises adjusting the cache-worthiness value of a first one of said plurality of objects, and said first one of said plurality of objects is removed from the cache between said first time and said second time.

12. The method of claim 1, wherein said cache-worthiness data comprises central processing unit (CPU) utilization data and requests for one or more of said plurality of objects.

13. The method of claim 12, wherein said determining comprises:
(a) adjusting the cache-worthiness value corresponding to each of said requested objects by a first increment; and
(b) adjusting the cache-worthiness value of each object stored in the cache by a second increment, wherein said second increment is a function of said CPU utilization data.

14. The method of claim 1, wherein said one or more objects are selected to maximize total cache-worthiness subject to a constraint comprising the size of the cache.

15. The method of claim 1, wherein objects are selected from the group consisting of tables, columns, records, cells, and constraints.

16. The method of claim 1, wherein said determining reflects a decreasing marginal utility of cumulative cache-worthiness data.

17. The method of claim 1, further comprising initializing said cache-worthiness values.

18. The method of claim 17, wherein said initial cache-worthiness values are indicative of cache-worthiness data available when said values are initialized.

19. The method of claim 1, wherein said plurality of objects is chosen based on user preference from the objects stored in the database.

20. The method of claim 1, wherein said plurality of objects is chosen randomly from the objects stored in the database.

21. The method of claim 1, further comprising determining whether the selected objects are stored in the cache, and if not, copying the selected objects from the database to the cache.

22. A method for controlling caching of database objects, comprising:
associating a cache-worthiness value with a database object; and
caching said database object when the associated cache-worthiness value satisfies a pre-determined criterion.

23. The method of claim 22 further comprising removing a database object from a cache when the associated cache-worthiness value no longer satisfies said predetermined criterion.

24. The method of claim 23, wherein said pre-determined criterion comprises maximization of a total cache-worthiness of said cache subject to a constraint comprising the size of said cache.

25. In a database system wherein objects are stored in a database, computer executable software code for selecting one or more of the objects to be stored in a cache, comprising:
code to collect cache-worthiness data for a plurality of objects in the database;
code to determine a cache-worthiness value for each of said plurality of objects using said data; and
code to select one or more of said plurality of objects to be stored in the cache, wherein the objects are selected using said cache-worthiness values.

26. The software code of claim 25, wherein said cache-worthiness data comprises requests for one or more of said plurality of objects.

27. The software code of claim 25, wherein said data comprises central processing unit (CPU) utilization data.

28. The software code of claim 25, further comprising code to initialize said cache-worthiness values.

29. The software code of claim 28, further comprising code to determine whether the selected objects are stored in the cache, and if not, to copy the selected objects from the database to the cache.

30. A system comprising:
a database;
a plurality of objects stored in said database, wherein a cache-worthiness value is associated with each of said objects
a cache, coupled to said database; and
means for populating said cache from said plurality of objects based on said cache-worthiness values.

31. The system of claim 30, wherein said means for populating comprises:
means for collecting cache-worthiness data corresponding to said plurality of objects;
means for determining said cache-worthiness values using said cache-worthiness data;
means for selecting one or more of said plurality of objects using said cache-worthiness values; and
means for copying said selected objects from said database to said cache.

32. The system of claim 31, wherein said database and said cache are configured in an inline cache configuration.

33. The system of claim 31, wherein said database and said cache are configured in a parallel cache configuration.
